(19) United States
(12) Patent Application Publication
(10) Pub. No.: US 2010/0058051 A1
(43) Pub. Date: Mar. 4, 2010

(54) METHOD AND APPARATUS FOR SETTING A SECURE COMMUNICATION PATH BETWEEN VIRTUAL MACHINES

(75) Inventor: Yuji Imai, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/546,296

(22) Filed: Aug. 24, 2009

(30) Foreign Application Priority Data
Sep. 2, 2008 (JP) 2008-224865

(51) Int. Cl. H04L 9/00

(52) U.S. Cl. 713/152

(57) ABSTRACT

A secure communication path is set between virtual machines each arranged within one of a set of servers in a network. There is provided business software operated by executing one or more task programs each provided for a virtual machine, and each server is provided with, as a virtual machine, a guest operating system controlled by a host operating system. The one or more task programs are classified into task classes according to a type of a function to be realized, and there is provided task connection information indicating whether a communication path is needed or not between each pair of task classes. Then, a secure communication path between a pair of guest operating systems is set by setting virtual network connection information to a pair of host operating systems corresponding to the pair of guest operating systems, on the basis of the task connection information.

### CROSS-REFERENCE TO RELATED APPLICATIONS

This application is based upon and claims the benefit of priority of the prior Japanese Patent Application No. 2008-224865, filed on Sep. 2, 2008, the entire contents of which are incorporated herein by reference.

### FIELD

The present invention relates to a technique for setting a secure communication path between virtual machines.

### BACKGROUND

Recently, the demand for out-sourcing information processing systems of enterprises or the like has increased and the market for such out-sourcing has been growing. A data center that contracts for such out-sourcing in a lump has a server node pool including a plurality of servers. Business programs used for processing client business whose out-sourcing has been entrusted are distributed and arranged among the plurality of servers included in the server node pool in accordance with their functions, and these servers are physically connected with each other in a network.

In such a server node pool, a technique for setting a virtual machine environment for each server in order to divide and manage business relating to a plurality of clients is generalized. Specifically, in each server, acting as a virtual operating system (hereinafter, referred to as a virtual OS (Operating System)), a host OS which is the basis of the virtual machine environment is operated and guest OSs are respectively operated as business program executing environments, by which inter-client mixing of data processed using business programs of clients can be avoided even in the case where business programs of a plurality of clients are to be processed on the same server. In addition, in such a data center, an inter-server physical network is shared among the plurality of clients, so that the following technique is also adopted. That is, a network is virtually divided by partitioning the inter-server physical network in L2 (Layer-2) partitions using the VLAN (Virtual Local Area Network) technique or by partitioning it using VPN (Virtual Private Network), so as to build virtual intranets for respective clients.

Here, in operation of a server node pool, in the case that a guest OS is newly started up for a server in which the corresponding business program has not being executed so far, it is necessary to newly connect, on a virtual network basis, the server for which the guest OS has been newly started up with other servers so as to perform data transmission and reception therebetween.

However, the burden of setting up a new virtual network connection is heavy. This is because that identifying a server to be connected with is difficult due to a complexity of a server configuration in a server node pool, and that, in order to set up a virtual network connection, ensuring a security by using an encryption technique is needed to avoid information leakage, invalid access and the like. In addition, for encryption, an encryption key for enciphering transmission data should be set to each server as a security policy. Moreover, it is desirable, from the viewpoint of security enhancement, that a different security policy is set to each of servers to be connected with on the virtual network basis. However, when a security policy is different for each of the servers as mentioned above, setting up thereof becomes further complicated and requires much time and labor.

United States Patent Application Publication No. 2002/0069369 discloses a technology for providing computer services to customers using virtual machines.

### SUMMARY

According to an aspect of the invention, there is provided a method for setting a secure communication path between virtual machines each arranged within a server included in a set of servers in a network. The method includes providing business software that is operated by executing one or more task programs each provided for a virtual machine, and further includes providing each of the set of servers with, as a virtual machine, a guest operating system controlled by a host operating system thereof, the guest operating system executing a task program that handles a part of process to be operated by the business software, the host operating system controlling a secure communication between the guest operating system and another server included in the set of servers. The one or more task programs are classified into task classes according to a type of a function to be realized thereby, and there is provided task connection information including information on whether a communication path is needed or not between each pair of task classes, and encryption information including information on whether an encryption of transmission data is needed or not between each pair of task classes between which a communication path is needed. From among the set of servers, a first server different from servers in which the one or more task program are executed is selected, and provided with a first task program belonging to a first task class for handling a part of process to be operated by the business software. Then, a first guest operating system provided for the first server is started up so as to make the first task program ready to be executed. Next, from among the set of servers, a second server with which the first task program is to communicate, is selected on the basis of the task connection information, and it is determined whether an encryption of transmission data is needed or not between the first task program and the selected second server, on the basis of the encryption information. Then, encryption setting information is set to both a first host operating system provided for the first server and a second host operating system provided for the second server when it is determined that an encryption of transmission data is needed between the first task program and the selected second server, and a secure communication path between the first guest operating system and a second guest operating system provided for the second server is set by setting virtual network connection information to both the first and second host operating systems, so as to operate the business software by executing the first task program as well as the one or more task programs.

The object and advantages of the invention will be realized and attained by means of the elements and combinations particularly pointed out in the claims.

It is to be understood that both the foregoing general description and following detailed description are exemplary and explanatory and are not restrictive of the invention, as claimed.

### BRIEF DESCRIPTION OF THE DRAWINGS

FIG. 1 is a diagram illustrating an example of a structure of a system for setting a secure virtual communication path between virtual machines, according to an embodiment;

FIG. 2 is a diagram illustrating an example of a configuration of a virtual machine, according to an embodiment;

FIG. 3A is a diagram illustrating an example of a routing setting table according to an embodiment;

FIG. 3B is a diagram illustrating an example of a tunneling setting table according to an embodiment;

FIG. 4 is a diagram illustrating an example of a configuration of a management server, according to an embodiment

FIG. 5 is a diagram illustrating an example of a connection plan table, according to an embodiment;

FIG. 6 is a diagram illustrating an example of a task management table, according to an embodiment;

FIG. 7 is a diagram illustrating an example of a server management table, according to an embodiment;

FIG. 8 is a diagram illustrating an example of a connection management table, according to an embodiment;

FIG. 9 is a diagram illustrating an example of connection relations between servers, according to an embodiment

FIG. 10 is a diagram illustrating an example of a flowchart of an operation for setting a secure virtual communication path between servers, according to an embodiment;

FIG. 11 is a diagram illustrating an example of a configuration for setting a secure virtual communication path between servers, according to an embodiment;

FIG. 12A is a diagram illustrating an example of a connection plan table, according to an embodiment;

FIG. 12B is a diagram illustrating an example of a task management table, according to an embodiment;

FIG. 12C is a diagram illustrating an example of a server management table, according to an embodiment;

FIG. 12D is a diagram illustrating an example of a connection management table, according to an embodiment;

FIG. 13A is a diagram illustrating an example of a routing setting table, according to an embodiment;

FIG. 13B is a diagram illustrating an example of a tunneling setting table, according to an embodiment;

FIG. 14A is a diagram illustrating an example of a routing setting table, according to an embodiment;

FIG. 14B is a diagram illustrating an example of a tunneling setting table, according to an embodiment;

FIG. 15 is a diagram illustrating an example of a configuration for setting a secure virtual communication path between servers, according to an embodiment;

FIG. 16A is a diagram illustrating an example of a tunneling setting table, according to an embodiment;

FIG. 16B is a diagram illustrating an example of a routing setting table, according to an embodiment;

FIG. 17A is a diagram illustrating an example of a tunneling setting table, according to an embodiment;

FIG. 17B is a diagram illustrating an example of a routing setting table, according to an embodiment;

FIG. 18A is a diagram illustrating an example of a server management table, according to an embodiment; and

FIG. 18B is a diagram illustrating an example of a connection management table, according to an embodiment.

### DESCRIPTION OF EMBODIMENTS

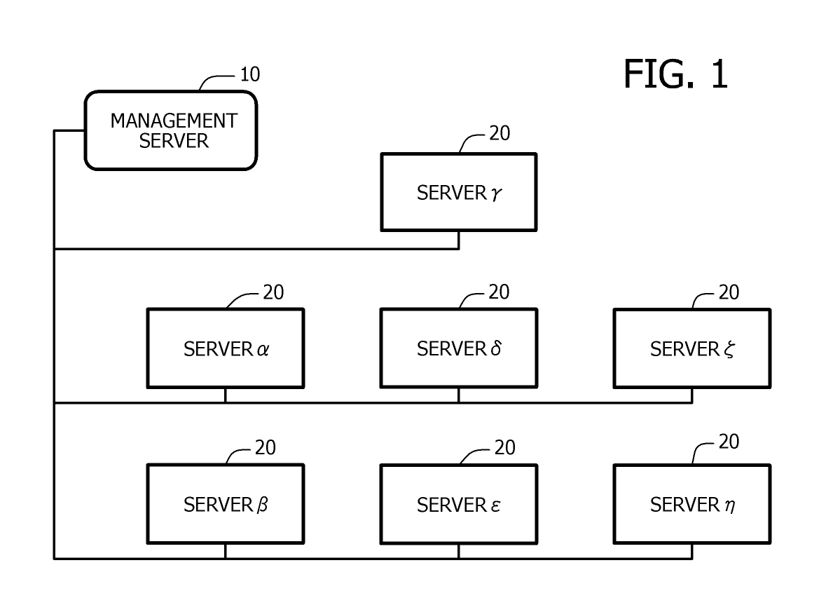

FIG. 1 is a diagram illustrating an example of a structure of a system for setting a secure communication path between virtual machines, according to an embodiment. The system is an example that is built in a server node pool (or a set of servers) installed in a data center for batch-processing a plural pieces of business software, in which an management server 10 and a plurality of servers 20 for processing the plural pieces of business software are connected each other via a network. The management server 10 generally manages all the servers 20 and performs various settings for the servers 20 by remote control. In addition, each of the management server 10 and the servers 20 comprises a computer including a CPU (Central Processing Unit) and a memory.

In the plurality of servers 20 included in the server node pool (or the set of servers), a plural pieces of business software for a plurality of clients who have entrusted outsourcing thereof to the data center can be operated. Each server 20 is provided with a virtual machine capable of operating a virtual OS. Further, by connecting the servers 20 each other on the P2P (Peer to Peer) basis using a virtual (private) network (for example, VPN: Virtual Private Network), the system is divided into parts each corresponding to a client so as to build virtual intranets. The virtual intranets built by dividing the system as mentioned above are connected to respective systems belonging to the clients.

The above mentioned business software can be operated by executing one or more task programs each provided for a virtual machine, and each of the set of servers can be provided with, as a virtual machine, a guest operating system controlled by a host operating system thereof, where the guest operating system executes a task program that handles a part of processing to be operated by the business software, and the host operating system controls a secure communication between the guest operating system and another server included in the set of servers.

Hereinafter, an example in which a VPN connection is used will be described as a representative example of a communication path between virtual machines.

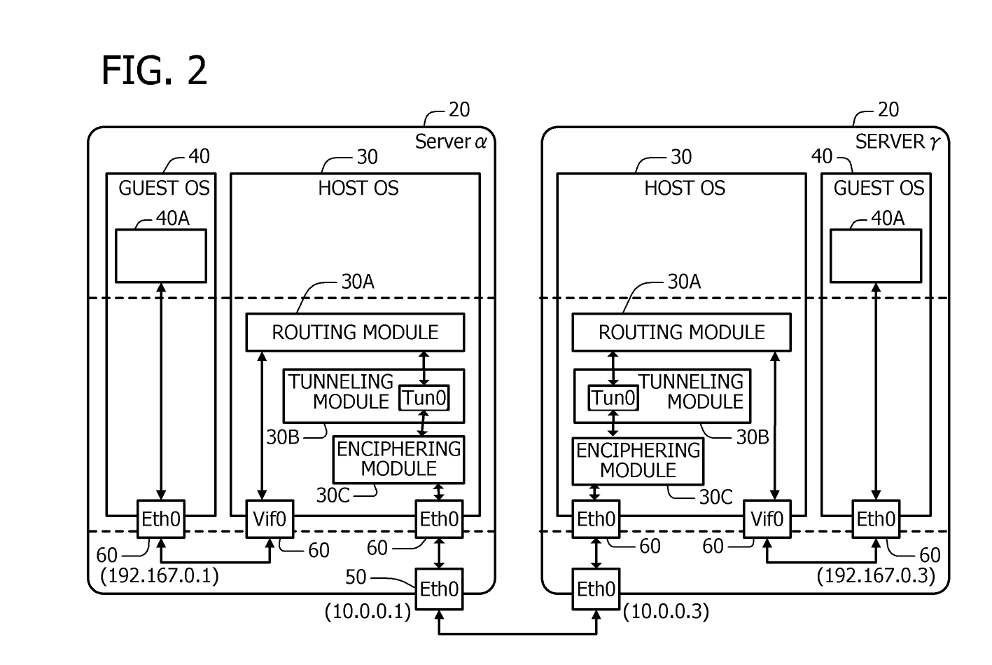

First, the configuration of server 20 provided with such a virtual machine, and the mechanism of VPN connection between servers 20 will be described with reference to FIG. 2.

FIG. 2 is a diagram illustrating an example of a virtual machine, according to an embodiment.

In server 20, the virtual machine is built so that host OS 30 and guest OS 40 operate as virtual OSs. Host OS 30 and guest OS 40 are controlled by a hypervisor functioning as an OS control program.

In addition, a server 20 is provided with a physical NIC (Network Interface Card) 50 used for performing communication between the own server and other servers. A physical IP address that is uniquely determined within the server node pool is allocated to each of servers 20. In addition, each of the host OS and the guest OS 40 that operate within a server 20 has a virtual NIC 60 and a communication between the host OS 30 and the guest OS 40 within the same server 20 is performed by using the virtual NICs 60. A client IP address serving as a virtual IP address that is an original address different from the physical IP address is allocated to the guest OS 40 that operates within the server 20.

Host OS 30 can be configured to include the following elements: a routing module 30A, a tunneling module 30B, and an enciphering module 30C.

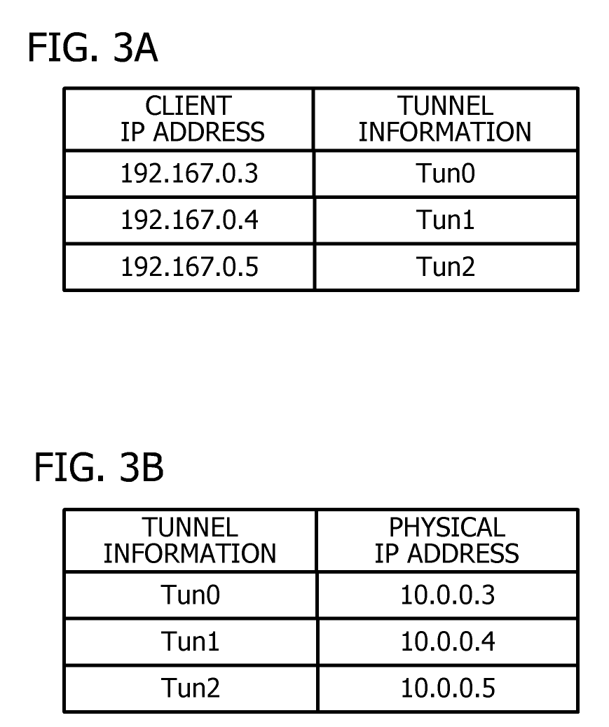

The routing module 30A specifies tunnel information that is needed for transmitting, via a VPN connection, data received from the guest OS 40. This routing module 30A is provided with a routing setting table that includes client IP addresses of destinations and tunnel information used in VPN connection to the destinations as depicted in FIG. 3A. A tunnel used for VPN communication is specified from the client IP address appended to the transmission data with reference to the routing setting table.

A tunneling module 30B performs tunneling of transmission data by appending a physical IP address of a destination to the transmission data and encapsulating the transmission data. The tunneling module 30B is provided with a tunneling setting table in which tunnel information and a physical IP address of the opposite end of a tunnel corresponding thereto are set for each piece of tunnel information as depicted in FIG. 3B. Here, the physical IP address of the opposite end of the tunnel becomes the destination of the encapsulated transmission data. Then, the tunneling module 30B specifies the physical IP address of the destination of the encapsulated transmission data corresponding to a given tunnel information on the basis of the tunneling setting table.

An enciphering module 30C enciphers transmission data and decodes received data. The enciphering module 30, which has a function analogous to an IPSec module or the like, functions as a key managing daemon. When data is received from another server 20, the enciphering module 30C of the host OS 30 decodes the received data, the tunneling module 30B decapsulate the decoded data, and then the decapsulated data is transmitted to the guest OS 40 pointed by the client IP address that is appended to the received data by the routing module 30A.

On the other hand, the guest OS 40 is configured to include a client business processing module 40A for executing a task program that handles a part of process to be processed by the business software. Although only one guest OS is operating in the example depicted in FIG. 2, it is also possible to operate a plurality of guest OSs.

Here, in the example depicted in FIG. 2, a data processing flow will be described, in which a task program executed by the client business processing module 40A of the guest OS 40 of a server α, transmits data to a task program that is executed in the client business processing module 40A of the guest OS 40 of a server γ. First, by the task program executed in the client business processing module 40A of the server α, data is transmitted to a destination of a client IP address (192. 167. 0. 3) of the guest OS 40 of the server γ. In the server α, the data is sent to the host OS 30 via a virtual NIC 60 (eth0) of the guest OS 40 and via a virtual NIC (vif0) of the host OS 30. Then, in the host OS 30, the routing module 30A obtains tunnel information corresponding to the client IP address of the destination with reference to the routing setting table in the routing module 30A. Further, in the host OS 30, the tunneling unit 30B obtains a physical IP address (10. 0. 0. 3) of the destination server corresponding to the tunnel information with reference to the tunneling setting table. Then, the obtained physical IP address is appended to the transmission data which is then encapsulated so as to perform tunneling. Next, the enciphering module 30C server a enciphers the transmission data by using an encryption key according to the encryption system applied to the server γ. Specifically, when the encryption system applied to the server γ is a public key encryption system in which a key used for encryption is open to the public and a key used for decoding is managed in secret, the transmission data will be enciphered using a public key. When the encryption system applied to the server γ is a secret key encryption system in which a common secret key is used for encryption and decoding, the transmission data will be enciphered using a secret key. By this, it becomes possible to perform VPN connection between the server α and the server γ in a secure manner. Then, the transmission data is transmitted from the virtual NIC 60 (eth0) of the host OS 30 of the server α to the server γ via the physical NIC 50 (eth0) of the server α. On the other hand, in the host OS 30 of the server γ which has received the data, the received data is decoded and then the decoded data is transmitted to a destination of the guest OS 40 where the task program is to be executed, on the basis of the client IP address appended to the decoded data.

By adopting such a configuration as mentioned above, in the case that the task program transmits and receives data between the own server and the other servers 20, the guest OS 40 needs only to set the client IP address of the destination at the transmission data so that the host OS 30 performs VPN connection processing such as setting of physical IP address and encryption. Therefore, it is not necessary for a client to directly control the host OS 30 of a server when accessing the server to execute a task program thereof and perform VPN connection between the server and other servers. Thus, communication with other servers becomes possible without authorizing the client to control the host OS 30, thereby preventing such a trouble that the client erroneously changes the setting of the environment of the host OS 30.

Next, the management server 10 for generally managing these servers 20 will be described.

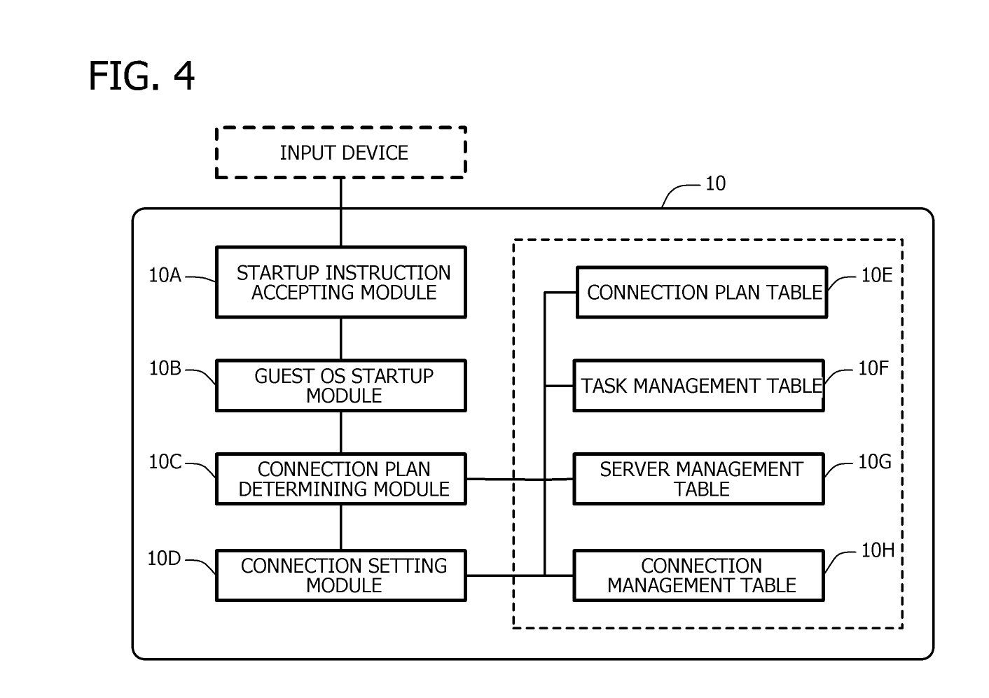

FIG. 4 is a diagram illustrating an example of a configuration of an management server, according to an embodiment. The management server 10 can be configured to include a startup instruction accepting module 10A, a guest OS startup module 10B, a connection plan determining module 10C, a connection setting module 10D, a connection plan table 10E, a task management table 10F, a server management table 10G, and a connection management table 10H.

The startup instruction accepting module 10A, connected with an input device that a user can operate, accepts a startup instruction for executing a task program by starting up a guest OS 40. The startup instruction designates a startup object server (or a first server) within which a new guest OS 40 is to be started up, and a task program to be executed therein.

The guest OS startup module 10B instruct a server 20 in which host the OS 30 is operated under control of the hypervisor and the guest OS 40 is ready to run, to start up a new guest OS 40 so as to execute a task program.

The connection plan determining module 10C determines a connecting destination server (or a second server) that is a server to be connected, via a VPN, to the startup object server in which the guest OS 40 has been started up, and judges whether encryption of transmission data is needed or not between the startup object server and the connecting destination server.

The connection setting module 10D is communicably connected with the servers 20 via a network and sets encryption setting information indicating a security policy and virtual network connection information to both the host OS 30 of the startup object server and to the host OS 30 of the connecting destination server.

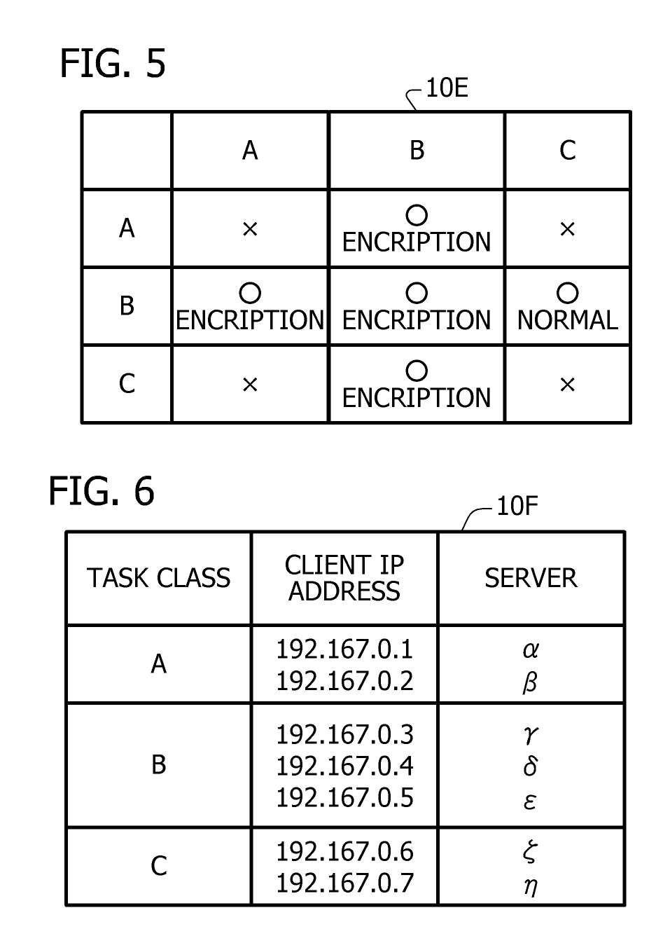

FIG. 5 is a diagram illustrating an example of a connection plan table according to an embodiment. The connection plan table 10E depicted in FIG. 4 is a table including task connection information indicating whether VPN connection is needed or not between a pair of task classes, where a task class is a set of task programs realizing the same type of function.

For example, as depicted in FIG. 5, information on whether a VPN connection is needed or not between a pair of task classes is registered therein. When a VPN connection is needed, information on whether encryption of transmission data is necessary or not between the pair of task classes necessary is also registered. In the example depicted in FIG. 5, three task classes are denoted by “A”, “B”; and “C”, respectively, “o” indicates that connection is needed between the corresponding pair of task classes, and “x” indicates that connection is not needed therebetween. Further, “ENCRYPTION” indicates that encryption of transmission data is needed between the corresponding pair of task classes, and “NORMAL” indicates that encryption of transmission data is not needed between the corresponding pair of task classes. In this manner, the connection plan table 10E can be configured to include task connection information that is information on whether connection is needed or not between task classes, and encryption information that is information on whether encryption of transmission data is necessary or not both between task programs of the same task class and between task programs of different task class.

FIG. 6 is a diagram illustrating an example of a task management table according to an embodiment. The task management table 10F depicted in FIG. 4 is a table for storing, in association with a task class, information on a server 20 that executes a task program belonging to the task class. As depicted in FIG. 6, in association with each of task classes, a client IP address of a guest OS 40 executing a task program belonging thereto, and server identifier identifying a server including the guest OS 40 are stored in the task management table 10F.

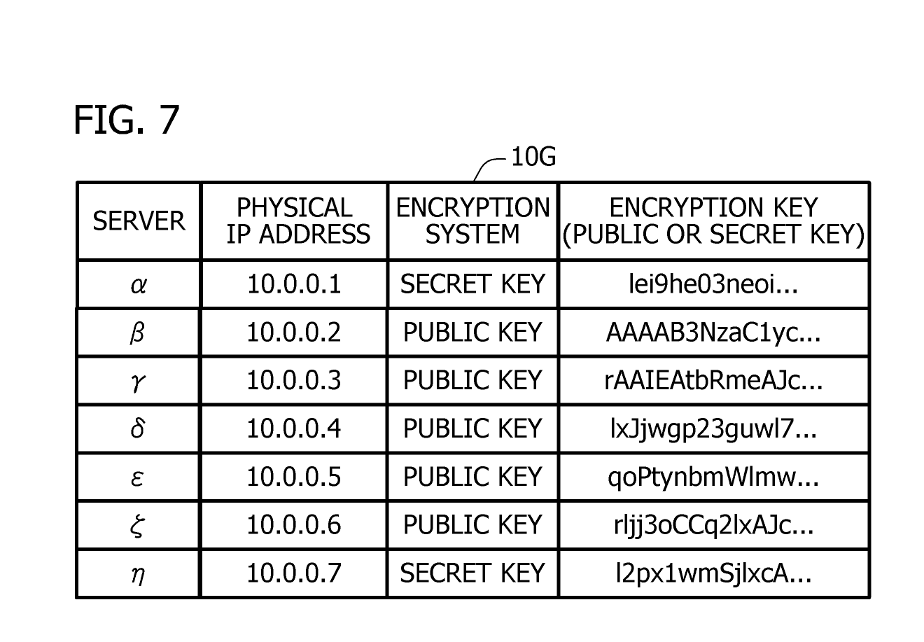

FIG. 7 is a diagram illustrating an example of a server management table according to an embodiment. The server management table 10G depicted in FIG. 4 is a table for storing, in association with a server identifier identifying a server 20, a physical IP address of the server 20 and information on encryption of the server 20. As depicted in FIG. 7, in association with each of server identifiers, the physical IP addresses of a server identified by the server identifier, an encryption system applied to the server and an encryption key used for enciphering transmission data to the server are stored in the server management table 10G. Here, when an encryption system applied to a server is a public key encryption system, a public key will be stored as an encryption key, and when an encryption system applied to a server is a secret key encryption system, a secret key will be stored as an encryption key.

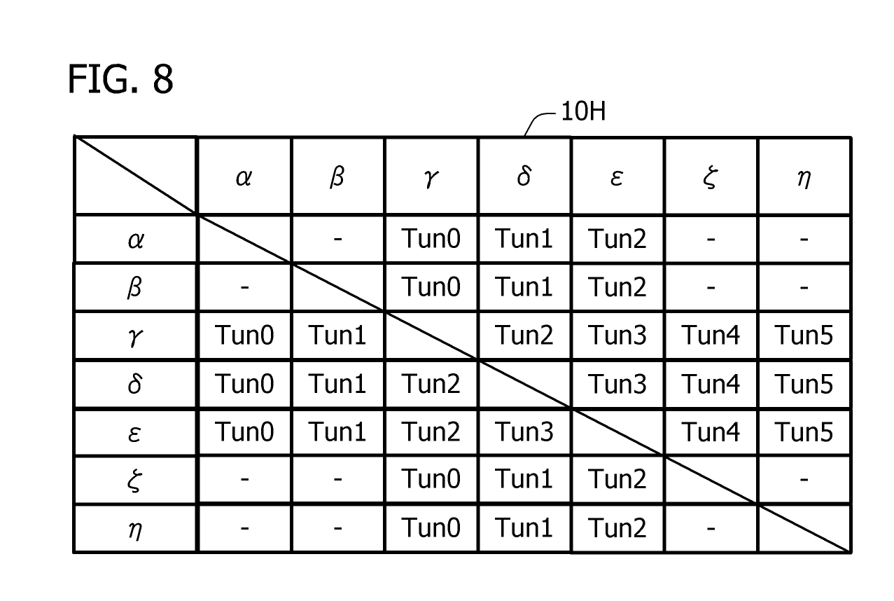

FIG. 8 is a diagram illustrating an example of a connection management table according to an embodiment. The connection management table 10H depicted in FIG. 4 is a table for storing information on a tunnel used in VPN connection between servers 20. As depicted in FIG. 8, information on a tunnel is stored in association with a pair of server identifiers identifying a transmission source server and a transmission destination server, respectively.

Here, it will be described how servers 20 are VPN-connected with each other on the basis of the above mentioned connection plan table 10E in which information on whether VPN connection is needed or not and information on whether encryption of transmission data is necessary or not are stored in association with each of pairs of task classes.

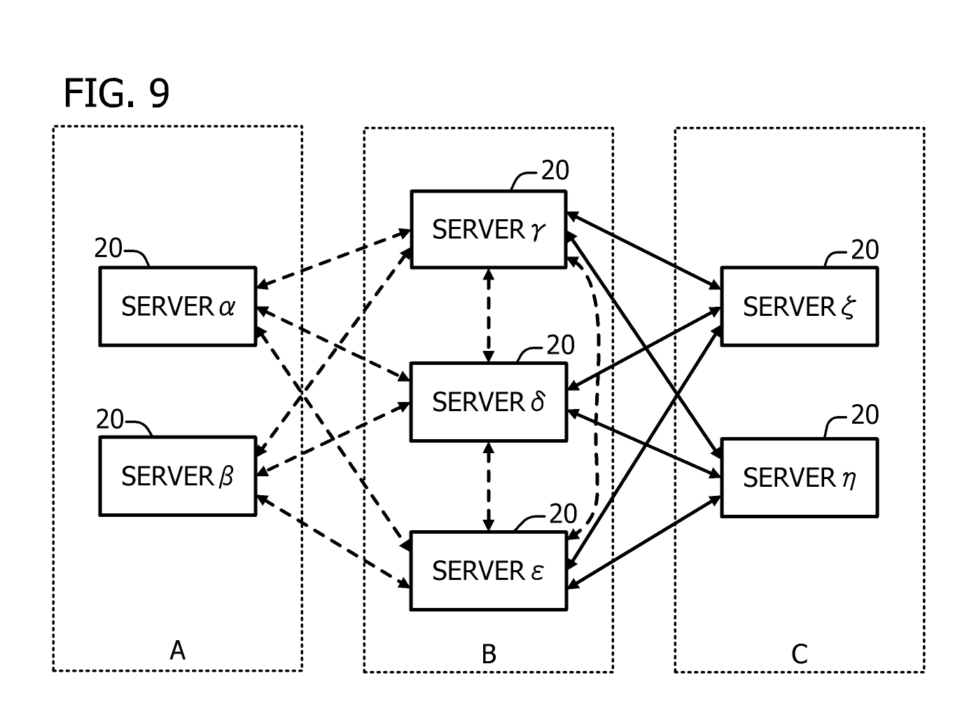

FIG. 9 is a diagram illustrating an example of connection relations between servers, according to an embodiment. FIG. 9 illustrates an example of connection relations between servers in the case of the connection plan table 10E depicted in FIG. 5, in which a solid-line arrow indicates the VPN connection without encryption and a broken-line arrow indicates the VPN connection with encryption. In this example, it is assumed that the server α and a server β execute task programs belonging to task class A, the server γ, a server δ, and a server ε execute task programs belonging to task class B, and a server ξ and a server η execute task programs belonging to task class C. According to the connection plan table 10E depicted in FIG. 5, connection between the same task classes A and between task classes A and C are not needed (x), on the other hand, connection between task classes A and B, between the same task classes B, and between task classes B and C are needed (o). Connection between task classes A and B and between the same task classes B needs encryption of transmission data, on the other hand, connection between task classes B and C does not need encryption of transmission data. Therefore, as depicted in FIG. 9, each of the servers a and D of task class A need to be connected with each of the servers γ, δ, and ε of task class B, and transmission data therebetween need to be enciphered. On the other hand, servers α and β of task class A are not connected to servers ξ and η of task class C. The servers γ, δ, and ε of task class B need to be connected with each other and transmission data therebetween need to be enciphered. Further, the servers γ, δ, and ε of task class B need not to be connected with the servers ξ and η of task class C, and transmission data therebetween need not to be encrypted.

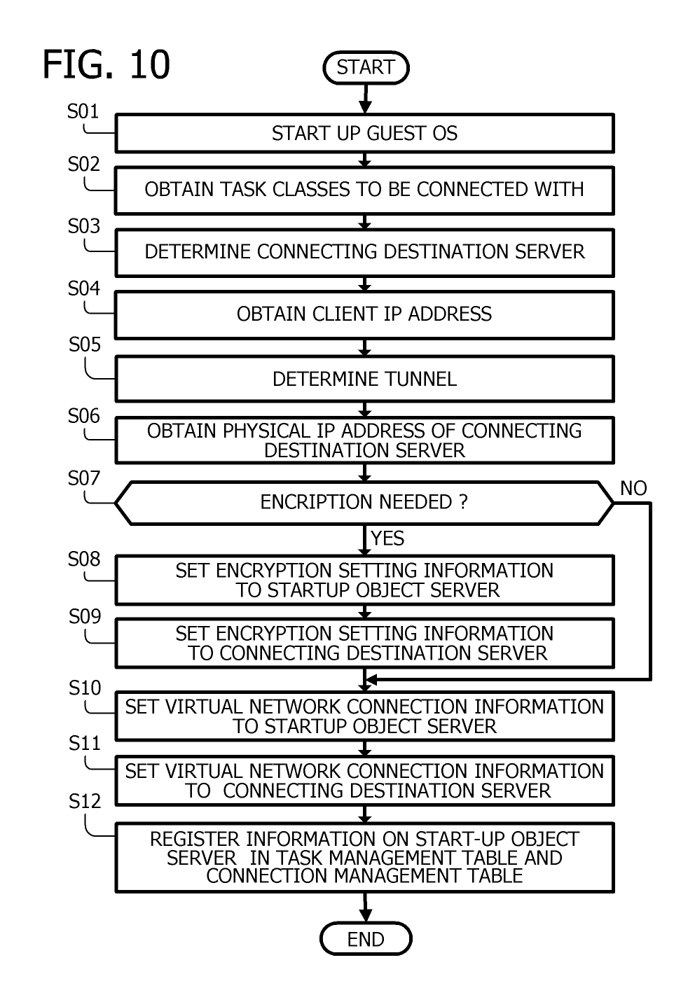

FIG. 10 is a diagram illustrating an example of a flowchart of an operation for setting a secure virtual communication path between servers, according to an embodiment. The connection setting process can be performed by startup instruction accepting module 10A, guest OS startup module 10B, connection plan determining module 10C, and network setting module 10D of management server 10. The network setting process can be executed when an operator has given a startup instruction to a startup object server so as to newly starts up a guest OS 40 and execute a task program thereon.

In step S01 (abbreviated as S01 in FIG. 10), a guest OS 40 is started up in the designated startup object server (or the first server) so that the designated task program becomes ready to be executed. At that time, a new client IP address is allocated to the started-up guest OS 40. Here, such allocation of a client IP address is performed so that the new client IP address does not duplicate a client IP address already being used.

It step S02, referring to the connection plan table 10E, all the task classes that are to be connected via a VPN connection with the task class of the designated task program to which a startup instruction has been given, are obtained, and it is determined whether encryption of transmission data is necessary or not in the VPN connection.

In step S03, referring to the task management table 10F, a server 20 executing a task program belonging to the task class obtained at step S02 is determined to be a connecting destination server (or a second server).

In step S04, referring to the task management table 10F, the client IP address of the guest OS 40 in the connecting destination server is obtained.

In step S05, a tunnel to be used for VPN connection between the startup object server and the connecting destination server is determined so as not to duplicate a tunnel which has been already used in each server.

In step S06, referring to a server management table 10G, the physical IP address of the connecting destination server is obtained.

In step S07, it is determined whether encryption of transmission data is needed between the startup object server and the connecting destination server on the basis of information, obtained at step S02, on whether encryption of transmission data is needed or not in the VPN connection between task classes. When encryption is needed (YES), the process proceeds to next step S08, and when encryption is not needed (NO), the process proceeds to step S10.

In step S08, an encryption key according to the encryption system of the connecting destination server is obtained from the server management table 10G, and the obtained encryption key is used as an encryption key for enciphering transmission data to the connecting destination server. Here, when the encryption system applied to the connecting destination server is a public key encryption system, a public key will be obtained and when it is a secret key encryption system, a secret key will be obtained. Then, the obtained encryption key is set to the enciphering module 30 of the startup object server, as encryption setting information, to the connecting destination server. In the case, the encryption setting information indicates a security policy of the VPN connection.

In step S09, an encryption key according to the encryption system of the startup object server is obtained from the server management table 10G, and the obtained encryption key is used as an encryption key for enciphering transmission data to the startup object server. Here, when the encryption system applied to the startup object server is a public key encryption system, a public key will be obtained and when it is a secret key encryption system, a secret key will be obtained. Then, the obtained encryption key is set to the enciphering module 30 of the connecting destination server, as encryption setting information, to the startup object server. In the case, the encryption setting information indicates a security policy of the VPN connection.

In step S10, in order to establish a VPN connection from the startup object server to the connecting destination server, a new tunnel is set to the tunneling module 30B of the startup object server in accordance with the tunnel information determined at step S05. That is, the tunnel information and the physical IP address of the connecting destination server are, as virtual network connection information, set to the tunneling setting table of the tunneling module 30B of the startup object server. Further, the client IP address of the connecting destination server and the tunnel information are, as virtual network connection information, set to the routing setting table of the routing module 30A of the startup object server.

In step S11, in order to establish a VPN connection from the connecting destination server to the startup object server, a new tunnel is set to the tunneling module 30B of the connecting destination server. That is, that tunnel information and the physical IP address of the startup object server are, as virtual network connection information, set to the tunneling setting table of the tunneling module 30B of the connecting destination server. Further, the client IP address of the startup object server and the tunnel information are, as virtual network connection information, set to the routing setting table of the routing unit 30A of the connecting destination server.

In step S12, the client IP address, the task class, and the server identifier of the startup object server are registered in the task management table 10F of the management server 10, and tunnel information between the startup object server and the connecting destination server is registered in the connection management table 10H of the management server 10.

In the above description, when a plurality of connecting destination servers have been determined at step S03, the steps S04 to S12 are executed for each of the plurality of connecting destination servers.

Here, a network setting process by the management server 10 will be described with reference to a specific example thereof.

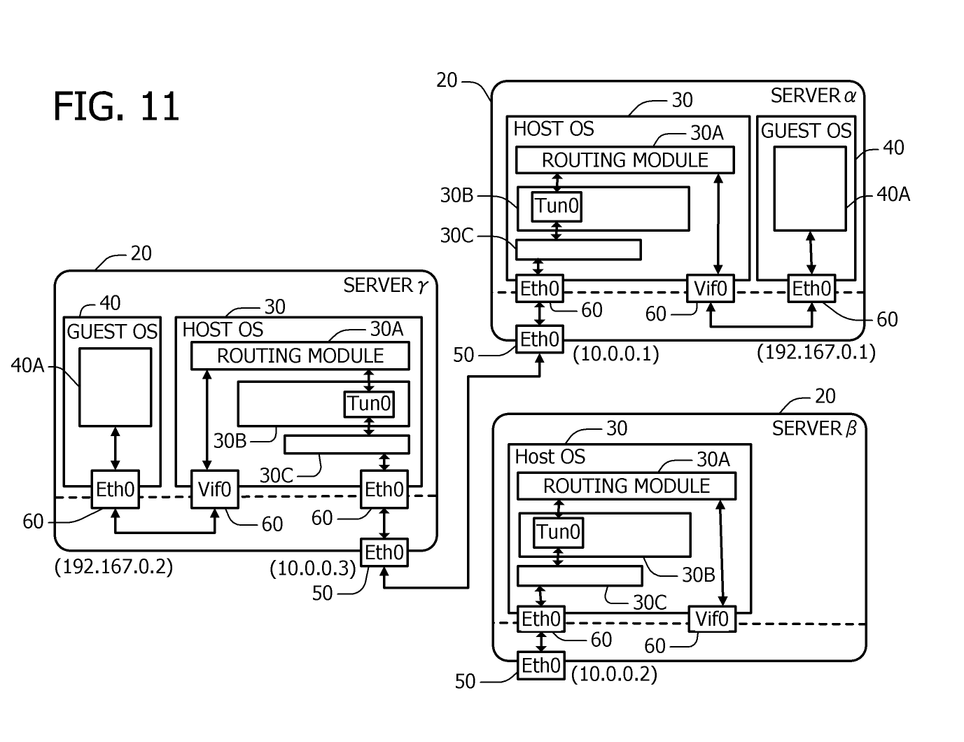

FIG. 11 is a diagram illustrating an example of a configuration for setting a secure communication path between virtual machines, according to an embodiment. In this example, a task program belonging to the task class A is executed by the server α and a task program belonging to the task class B is executed by the server γ. Then, it is assumed that a startup instruction has been given so as to newly start up a guest OS 40 in the server β and to execute a task program belonging to the task class A on the guest OS 40 of the server β. In FIG. 11, for convenience of explanation, description of physical network connection between the management server 10 and each server 20, and description of some modules of the configuration of each server 20 will be omitted. In addition, a solid-line arrow between the servers 20 indicates that VPN connection is made therebetween as a communication path.

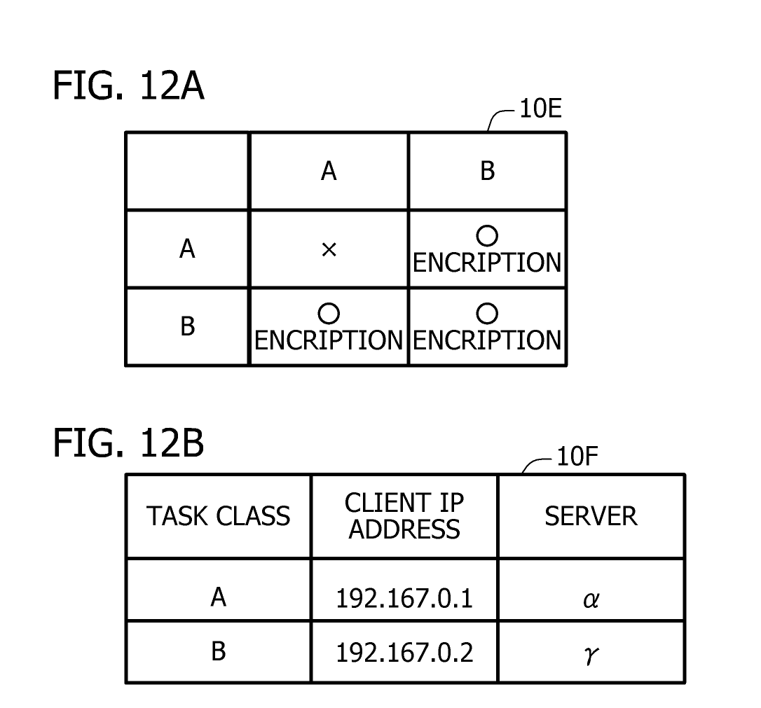

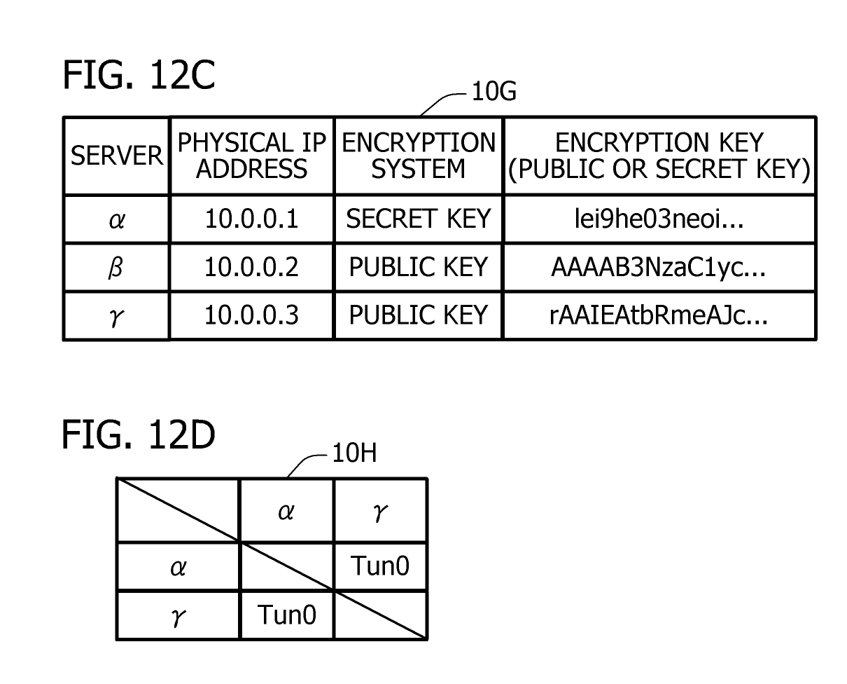

In this example, the connection plan table 10E, the server management table 10G, the task management table 10F, and the connection management table 10H of the management server 10 are set as depicted in FIGS. 12A-12D.

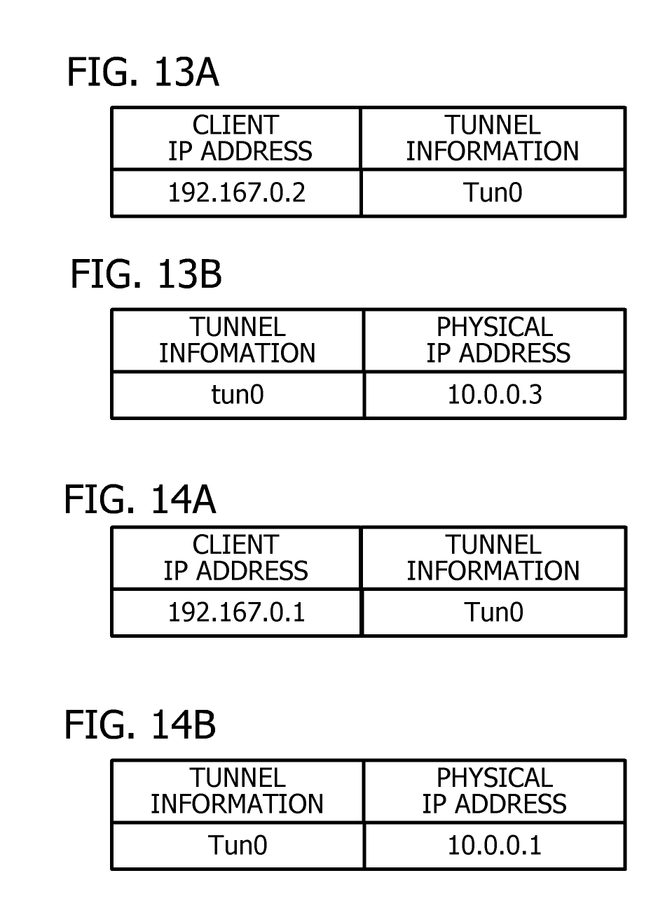

Further, in this example, data as depicted in FIGS. 13A and 13B are set, respectively, to the routing setting table of the routing module 30A and to the tunneling setting table of the tunneling module 30B of the server α. Also, data as depicted in FIGS. 14A and 14B are set, respectively, to the routing setting table of the routing module 30A and to the tunneling setting table of the tunneling module 30B of the server γ.

Then, when the startup instruction has been given, the management server 10 starts up the guest OS 40 in the server β and brings it into a state that a task program of the task class A can be executed thereon. At that time, a new client IP address (192. 167. 0. 3) is allocated to the started up guest OS 40 (corresponding to step S01 of FIG. 10). Here, referring to the connection plan table 10E, the management server 10 obtains all the task classes that are to be connected with the task class A including the task program to which the startup instruction has been given. In the case, the task class B is obtained. The management server 10 further obtains information on whether encryption of transmission data is needed or not for VPN connection to the task class B (corresponding to step S02). Further, referring to the task management table 10F, the management server 10 determines a server in which a guest OS 40 executing a task program belonging to the task class B is operating. In the case, the server γ is determined as the connecting destination server (corresponding to step S03), and a client IP address (192. 167. 0. 2) of that guest OS 40 is obtained (corresponding to step S04).

Further, tunnels used for VPN connection between the server β and the server γ are determined. In the case, “Tun0” is determined as a tunnel used for a VPN connection from the server β to the server γ, and “Tun1” is determined as a tunnel used for a VPN connection from the server γ to the server β (corresponding to step S05). Further, referring to the server management table 10G, a physical IP address (10. 0. 0. 3) of the server γ is obtained (corresponding to step S06).

Then, on the basis of the information in accordance with the connection plan table 10E obtained at step S02, it is determined that encryption of the VPN connection between the server β and the server γ is needed (corresponding to step S07). Next, referring to the server management table 10G, it is determined that the encryption system applied to the server γ is a public key system, and the public key thereof “rAAIEAtbRmeAJc . . . ” is obtained. Then, the public key “rAAIEAtbRmeAJc . . . ” is set to the enciphering module 30C of the server β, as an encryption key used for enciphering transmission data to the server γ (corresponding to step S08). Likewise, referring to the server management table 10G, it is determined that the encryption system applied to the server β is a secret key system, and the secret key thereof “AAAAB3NzaClyc . . . ” are obtained. Then, the secret key “AAAAB3NzaClyc . . . ” is set to the enciphering module 30C of the server γ, as an encryption key used for enciphering transmission data to the server β (corresponding to step S09).

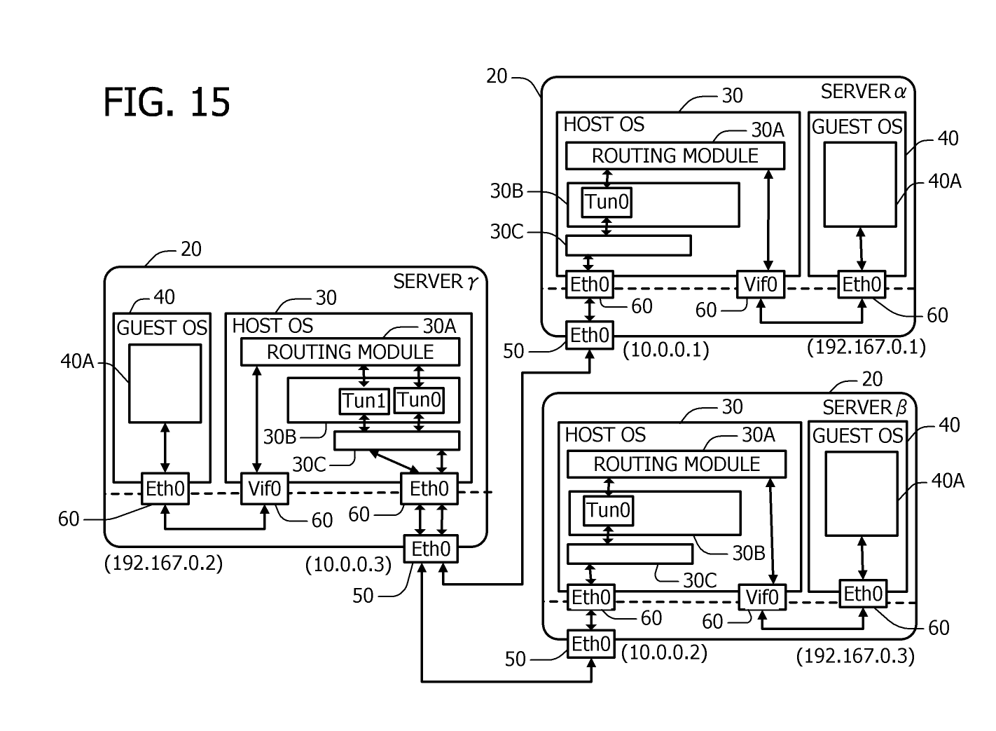

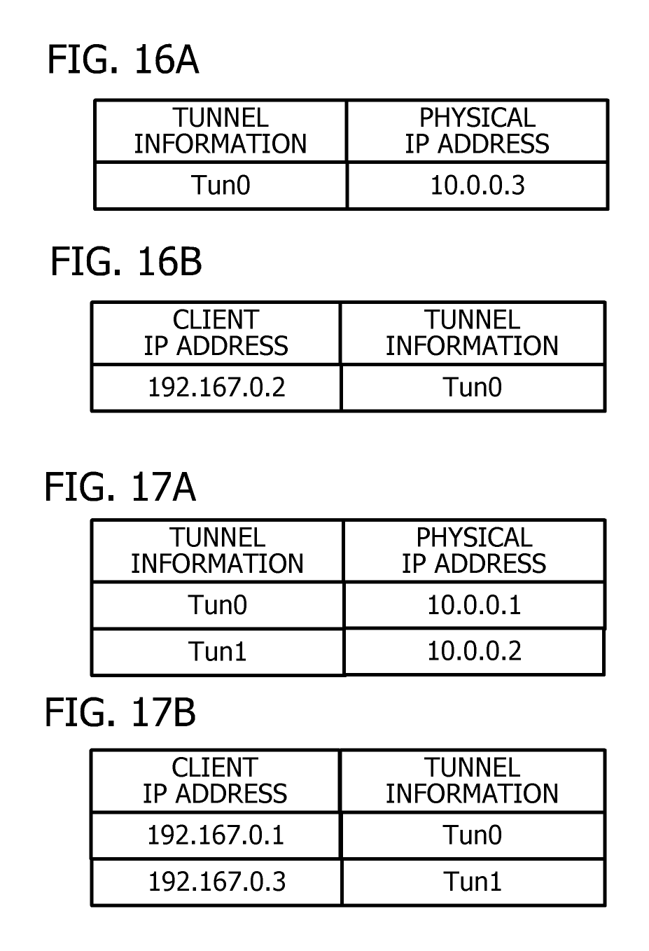

Further, for VPN connection from the server β to the server γ, a new tunnel (Tun0) is set to the tunneling module 30B of the server β as depicted in FIG. 15. In addition, that tunnel information (Tun0) and a physical IP address (10. 0. 0. 3) of the server γ are set to the tunneling setting table of the tunneling module 30B of the server β (the startup object server) as depicted in FIG. 16A. Further, the client IP address of the server γ and the tunnel information are set to the routing setting table of the routing module 30A of the server β (the startup object server) as depicted in FIG. 16B (corresponding to step S10).

On the other hand, for VPN connection from the server γ to the server β, a new tunnel (Tun1) is set to the tunneling module 30B of the server γ as depicted in FIG. 15. That is, the new tunnel information (Tun1) and the physical IP addresses of the server β are set in the tunneling setting table of the routing module 30B of the server γ (the connecting destination server) as depicted in FIG. 17A. Further, the client IP addresses of the server β and the tunnel information are set to the routing setting table of the routing module 30A of the server γ (the connecting destination server) as depicted in FIG. 17B (corresponding to step S11).

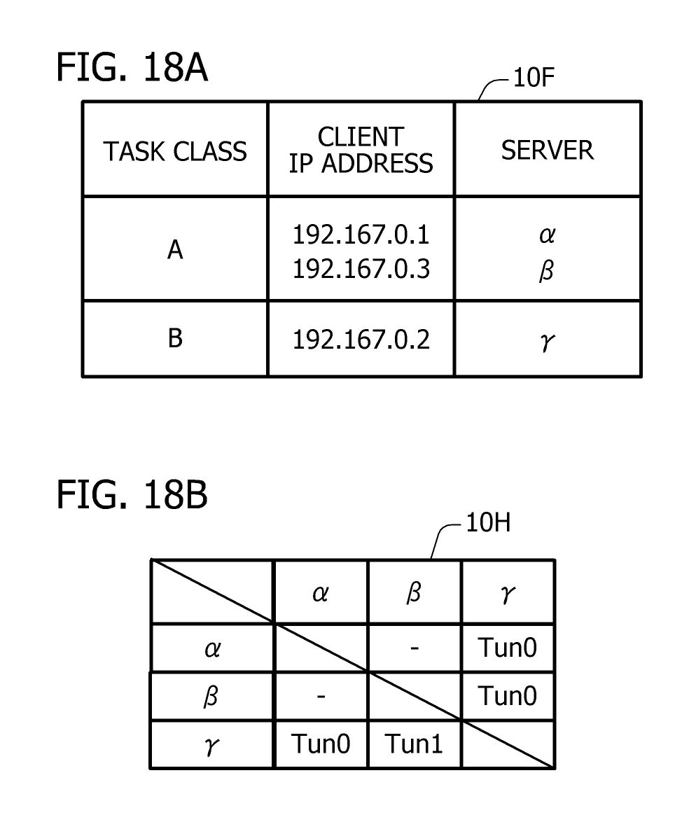

Then, in the task management table 10F of the management server 10, the server β is registered as a server for executing the task program belonging to the task class A together with a client IP address (192. 167. 0. 3) as depicted in FIG. 18A. In addition, in the connection management table 10H, the tunnel information (Tun0) from the server β to the server y and the tunnel information (Tun1) from the server γ to the server β are registered as depicted in FIG. 18B (corresponding to step S12).

According to the network setting process as mentioned above, when a new guest OS has been started up, a connecting destination server (or a second server) is automatically determined in accordance with a task program to be executed by the guest OS and it is determined whether encryption of transmission data in VPN connection is necessary or not between a startup object server (or first server) and the connecting destination server. In addition, virtual network connection information for establishing a VPN connection between the startup object server and the connecting destination server and encryption setting information (for example, a encryption key) as a security policy are automatically set to the host OS of each server. Therefore, when a new guest OS has been started up, the work of routing setting in each server and tunneling setting for VPN connection as well as the security policy setting work, can be eliminated. In setting the security policy, setting of a different encryption key can be performed depending on the server acting as a connecting destination server of the VPN connection. Therefore, in the VPN connection, the burden of setting up the network is drastically reduced while ensuring security of data transmission.

In addition, depending on an encryption system (a public key system or a secret key system) applied to a server that is the transmission destination of data, a public key or a secret key can be obtained as an encryption key which is set to the host OS of each server so as to encipher the transmission data. Therefore, even if a different encryption system is applied to each server included in a server node pool, the security policy can be automatically set in an appropriate manner.

As described above, it is possible to set, to the connection plan table 10E, information on whether connection is needed or not between the same business program classes, and information on whether encryption of transmission data is needed or not between the same business program classes. Therefore, the embodiment can be applied to the case of executing an another task program belonging to the same task class to which an existing task program that has already been executed belongs, so as to horizontally expand the function of a specific business software. On the other hand, it is also possible to set, to the connection plan table 10E, information on whether connection is needed or not between different task classes, and information on whether encryption of transmission data is needed or not between different task classes. Therefore, by registering, in advance, a new task class in the connection plan table 10E, the embodiment can be applied even to the case of conducting vertical expansion for executing a new task program belonging to a task class which has never been executed so far.

As mentioned above, according to the embodiment, network setting work can be automated in various forms of expansion of systems for executing business software.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A computer readable recording medium storing instructions for allowing a computer system to execute a procedure setting a secure communication path between virtual machines each arranged within a server included in a set of servers in a network, the procedure comprising:
providing business software that is operated by executing one or more task programs each provided for a virtual machine;
providing each of the set of servers with, as a virtual machine, a guest operating system controlled by a host operating system thereof, the guest operating system executing a task program that handles a part of process to be operated by the business software, the host operating system controlling a secure communication between the guest operating system and another server included in the set of servers;
classifying the one or more task programs into task classes according to a type of a function to be realized thereby;
providing task connection information including information on whether a communication path is needed or not between each pair of task classes, and encryption information including information on whether an encryption of transmission data is needed or not between each pair of task classes between which a communication path is needed;
selecting, from among the set of servers, a first server different from servers in which the one or more task program are executed;
providing the selected first server with a first task program belonging to a first task class for handling a part of process to be operated by the business software;
starting up a first guest operating system provided for the first server, so as to make the first task program ready to be executed;
selecting, from among the set of servers, a second server with which the first task program is to communicate, on the basis of the task connection information;
determining whether an encryption of transmission data is needed or not between the first task program and the selected second server, on the basis of the encryption information;
setting encryption setting information to both a first host operating system provided for the first server and a second host operating system provided for the second server when it is determined that an encryption of transmission data is needed between the first task program and the selected second server; and
setting a secure communication path between the first guest operating system and a second guest operating system provided for the second server by setting virtual network connection information to both the first and second host operating systems, so as to operate the business software by executing the first task program as well as the one or more task programs.

2. The computer readable recording medium of claim 1, wherein the procedure further comprises
providing a task management table for storing, in association with a task class, a server identifier identifying a server executing a task program belonging to the task class, wherein
a server executing a second task program belonging to a second task class with which the first task program is to communicate, is selected as the second server on the basis of the task connection information and the task management table, and
it is determined that an encryption of transmission data between the first server and the second server is needed when it is determined that an encryption of transmission data is needed between the first task class including the first task program and the second task class including the second task program on the basis of the encryption information.

3. The computer readable recording medium of claim 1, wherein the procedure further comprises
providing a server management table storing an encryption system identifier identifying an encryption system and an encryption key corresponding to the encryption system in association with each server included in the set of servers, wherein
data to be transmitted to a server included in the set of servers is encrypted by using an encryption system and an encryption key that are associated with the server in the server management table.

4. The computer readable recording medium of claim 3, wherein, in an entry of the server management table, a public key is stored as an encryption key when an encryption system of the entry is a public key system, and a secret key is stored as an encryption key when an encryption system of the entry is a secret key system.

5. A method for setting a secure communication path between virtual machines each arranged within a server included in a set of servers in a network, the method comprising:
providing business software that is operated by executing one or more task programs each provided for a virtual machine;
providing each of the set of servers with, as a virtual machine, a guest operating system controlled by a host operating system thereof, the guest operating system executing a task program that handles a part of process to be operated by the business software, the host operating system controlling a secure communication between the guest operating system and another server included in the set of servers;
classifying the one or more task programs into task classes according to a type of a function to be realized thereby;
providing task connection information including information on whether a communication path is needed or not between each pair of task classes, and encryption information including information on whether an encryption of transmission data is needed or not between each pair of task classes between which a communication path is needed;
selecting, from among the set of servers, a first server different from servers in which the one or more task program are executed;
providing the selected first server with a first task program belonging to a first task class for handling a part of process to be operated by the business software;
starting up a first guest operating system provided for the first server, so as to make the first task program ready to be executed;
selecting, from among the servers in which the one or more task program are executed, a second server with which the first task program is to communicate, on the basis of the task connection information;
determining whether an encryption of transmission data is needed or not between the first task program and the selected second server, on the basis of the encryption information;
setting encryption setting information to both a first host operating system provided for the first server and a second host operating system provided for the second server when it is determined that an encryption of transmission data is needed between the first task program and the selected second server; and
setting a secure communication path between the first guest operating system and a second guest operating system provided for the second server by setting virtual network connection information to both the first and second host operating systems, so as to operate the business software by executing the first task program as well as the one or more task programs.

6. The method of claim 5, further comprising
providing a task management table for storing, in association with a task class, a server identifier identifying a server executing a task program belonging to the task class, wherein
a server executing a second task program belonging to a second task class with which the first task program is to communicate, is selected as the second server on the basis of the task connection information and the task management table, and
it is determined that an encryption of transmission data between the first server and the second server is needed when it is determined that an encryption of transmission data is needed between the first task class including the first task program and the second task class including the second task program on the basis of the encryption information.

7. The method of claim 5, further comprising
providing a server management table storing an encryption system identifier identifying an encryption system and an encryption key corresponding to the encryption system, in association with each server included in the set of servers, wherein
data to be transmitted to a server included in the set of servers is encrypted by using an encryption system and an encryption key that are associated with the server in the server management table.

8. The method of claim 7, wherein, in an entry of the server management table, a public key is stored as an encryption key when an encryption system of the entry is a public key system, and a secret key is stored as an encryption key when an encryption system of the entry is a secret key system.

9. An apparatus for setting a secure communication path between virtual machines each arranged within a server included in a set of servers in a network, wherein there is provided business software that is operated by executing one or more task programs each provided for a virtual machine, and each of the set of servers is provided with, as a virtual machine, a guest operating system controlled by a host operating system thereof, the guest operating system executing a task program that handles a part of process to be operated by the business software, the host operating system controlling a secure communication between the guest operating system and another server included in the set of servers, the one or more task programs being classified into task classes according to a type of a function to be realized thereby, the apparatus comprising:
a connection plan table including task connection information and encryption information, the task information including information on whether a communication path is needed or not between each pair of task classes, the encryption information including information on whether an encryption of transmission data is needed or not between each pair of task classes between which a communication path is needed;
a startup instruction accepting module for selecting, from among the set of servers, a first server different from servers in which the one or more task program are executed, wherein the selected first server is provided with a first task program belonging to a first task class for handling a part of process to be operated by the business software;
a guest OS startup module for starting up a first guest operating system provided for the selected first server, so as to make the first task program ready to be executed;
a connection plan determining module for selecting, from among the servers in which the one or more task program are executed, a second server with which the first task program is to communicate, on the basis of the task connection information, and determining whether an encryption of transmission data is needed or not between the first task program and the selected second server, on the basis of the encryption information;
a connection setting module for setting encryption setting information to both a first host operating system provided for the first server and a second host operating system provided for the second server when it is determined that an encryption of transmission data is needed between the first task program and the selected second server, wherein a secure communication path between the first guest operating system and a second guest operating system provided for the second server is set by setting virtual network connection information to both the first and second host operating systems, so as to operate the business software by executing the first task program as well as the one or more task programs.

10. The apparatus of claim 9, further comprising
a task management table for storing, in association with a task class, a server identifier identifying a server executing a task program belonging to the task class, wherein
a server executing a second task program belonging to a second task class with which the first task program is to communicate, is selected as the second server, on the basis of the task connection information and the task management table, and
it is determined that encryption of transmission data between the first server and the second server is needed when it is determined that an encryption of transmission data is needed between the first task class including the first task program and the second task class including the second task program on the basis of the encryption information.

11. The apparatus of claim 9, further comprising
a server management table for storing an encryption system identifier identifying an encryption system and an encryption key corresponding to the encryption system, in association with each server included in the set of servers, wherein
data to be transmitted to a server included in the set of servers is encrypted by using an encryption system and an encryption key that are associated with the server in the server management table.

12. The apparatus of claim 11, wherein, in an entry of the server management table, a public key is stored as an encryption key when an encryption system of the entry is a public key system, and a secret key is stored as an encryption key when an encryption system of the entry is a secret key system.
